(19) United States
(12) Patent Application Publication
(10) Pub. No.: US 2015/0060322 A1
(43) Pub. Date: Mar. 5, 2015

(54) CLEANING PRODUCT EXHIBITING INCREASED STABILITY WITH CRYSTALLINE PARTICLES

(71) Applicant: The Dial Corporation, Scottsdale, AZ (US)

(72) Inventors: Gregory A. Konishi, Scottsdale, AZ (US); Joan M. Bergstrom, Scottsdale, AZ (US)

(73) Assignee: The Dial Corporation, Scottsdale, AZ (US)

(21) Appl. No.: 14/010,719

(22) Filed: Aug. 27, 2013

(51) Int. Cl. C11D 3/395

(52) U.S. Cl. CPC C11D 3/3951
USPC 206/525; 510/370

(57) ABSTRACT

Methods and apparatus are provided that exhibit increased stability with crystalline particles. A cleaning product includes a cleaning agent disposed within the cleaning product. The cleaning agent includes an oxidizing agent. Further, an alumina structuring agent disposed within the cleaning product includes crystalline particles having a crystallite size less than six nanometers.

### FIELD OF THE INVENTION

The present invention generally relates to a cleaning product exhibiting increased stability, and more particularly relates to a cleaning product exhibiting a reduced viscosity loss and reduced syneresis and/or separation with crystalline particles having a crystallite size less than six nanometers.

### BACKGROUND OF THE INVENTION

Homes and other buildings typically have many surfaces that may be prone to unsightly blemishes, such as stains, spills, smells and particulate matter. These surfaces may also be breeding grounds for harmful bacteria such as Escherichia coli. Such surfaces include appliance surfaces, floors, countertops, cooktops, sinks, tubs, toilets, and other hard surfaces.

Accordingly, it is desirable to have a cleaning product that removes the unsightly blemishes. In addition, it is desirable that the cleaning product disinfect the surfaces by killing the harmful bacteria. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A cleaning product exhibiting increased stability with crystalline particles includes a cleaning agent disposed within the cleaning product. The cleaning agent includes an oxidizing agent. The cleaning product also includes an alumina structuring agent disposed within the cleaning product. The alumina structuring agent includes crystalline particles having a crystallite size less than six nanometers.

A surface cleaning product exhibiting increased stability with crystalline particles includes a container and a cleaning product housed within the container. The cleaning product includes a cleaning agent disposed within the cleaning product. The cleaning agent includes an oxidizing agent. The cleaning product also includes an alumina structuring agent disposed within the cleaning product, the alumina structuring agent includes crystalline particles having a crystallite size less than six nanometers.

A method for forming a cleaning product exhibiting increased stability with crystalline particles includes collapsing a dispersion of an acid and a spray dried powder of an alumina structuring agent. The method also includes forming a network of particle-particle interactions. The method further includes combining the network with a cleaning agent that comprises an oxidizing agent. The alumina structuring agent comprises crystalline particles having a crystallite size less than six nanometers.

### BRIEF DESCRIPTION OF THE DRAWINGS

The present invention will hereinafter be described in conjunction with the following drawing figures, wherein like numerals denote like elements, and

FIG. 1 is a diagram of an example of applying a cleaning product to a stain on a hard surface according to the principles described herein; and

FIG. 2 is a flowchart of a method for forming a cleaning product exhibiting increased stability with crystalline particles according to the principles described herein.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Cleaning products may be liquids or gel compositions that constitute a number of chemicals that are combined to clean and disinfect surfaces. For example, a cleaning product may have a cleaning agent that may include water, a surfactant and an acid. The cleaning product may also have an alumina structuring agent. Over time, the cleaning product may degrade. When a cleaning product degrades, it may become less stable. Specifically, as a cleaning product ages, the cleaning product may thicken, i.e., it may become more viscous. The thicker fluid may be more difficult to use and thus may provide a less than satisfactory customer experience. Additionally, the constituent chemicals of the cleaning product may physically separate. For example, a liquid may be expelled from a gel in a process known as syneresis. In another example, a first liquid of the cleaning product may separate from a second liquid in the cleaning product. The physical separation and/or syneresis may degrade the ability of the cleaning product to clean and disinfect and in addition may lead to consumer dissatisfaction with the cleaning product.

The principles described herein include a mechanism for increasing the stability of a cleaning product that would otherwise degrade due to increased viscosity, the physical separation of constituent components of the cleaning product, or combinations thereof. Such a mechanism includes an alumina structuring agent that includes crystalline particles that have a crystalline size less than approximately six nanometers. As will be described below, a cleaning product with crystalline particles of this size may exhibit increased stability. In other words, a cleaning product with crystallize particles less than six nanometers may exhibit an increased viscosity stability and a reduced physical separation of the components of the cleaning product. All this while maintaining the active bleach level of the cleaning product. Maintaining stability in the cleaning product via crystalline particles less than six nanometers yields unexpected results as standard practice implements larger crystallite particles to improve stability.

As a result, the cleaning product's useful shelf life is prolonged while maintaining the potency of the cleaning and disinfecting properties of the cleaning product throughout the life of the cleaning product.

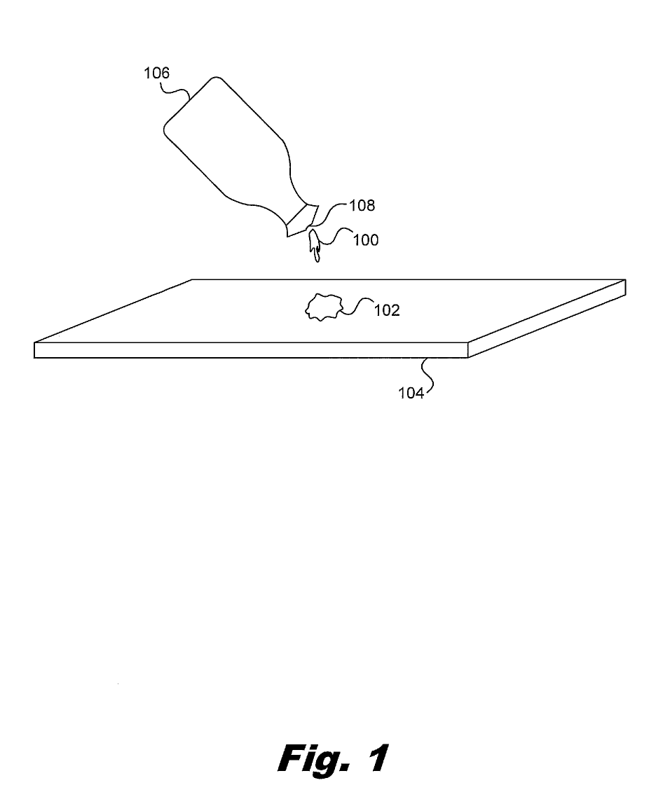

Turning now to the figures, FIG. 1 is a diagram of an example of applying a cleaning product (100) to a blemish (102) on a surface (104) according to the principles described herein. As used in the present specification, and in the appended claims, a blemish (102) may include a stain, particulate matter, liquid spill, dry spill, mold, mildew, smells, and grease, among other types of imperfections on a surface (104). Examples of surfaces (104) countertops, cooktops, appliance surfaces, floors, cabinets, windows, sinks, tubs, toilets among other hard surfaces. The cleaning product (100) may be used on a number of different surface (104) types. For example, the cleaning product (100) may be used on ceramic, porcelain, stainless steel, wood, glass, cast iron, plastic, tile, grout, paint, among other surface materials.

In this example, the cleaning product (100) is held within a container (106) that has an opening (108) that allows the cleaning product (100) to flow out of the container (106) onto the surface (104). In another example, the container (106) may be a spray-type container (106) that expels the cleaning product (100). For example, a user may depress a trigger on the spray-type container (106) which actuates a pump that draws liquid up a siphon tube and expels the cleaning product (100) out of a nozzle opening (108) of the spray-type container (106). In some examples, the cleaning product (100) may flow out of the container (106) onto a rag, or towel, to be rubbed onto the surface (104) by a user.

The container (106) may also include a brush or another mechanism with which a user can rub the cleaning product (100) onto the surface (104) after the cleaning product (100) has been applied to the blemished (102) areas of the surface (104). In other examples, the user can use other devices not attached to the container (106) to rub the cleaning product (100) onto the surface (104). Rubbing causes the cleaning product (100) to further penetrate the blemish (102).

While the cleaning product (100) will be described with specific reference to targeting hard surface (104) blemishes (102), any appropriate surfaces may be targeted in accordance with the principles described herein. For example, the blemishes (102) may be on a curtain, weather resistant fabric, among other surfaces (102).

The cleaning product (100) may include a cleaning agent. In some examples, the cleaning agent may include an oxidizing agent. The oxidizing agent may be any compound that breaks down chemical bonds of another molecule in a chemical reaction. For example, the oxidizing agent may remove a stain by breaking down the chemical bonds of the molecules of the stain. For example, an oxidizing agent may break the chemical bonds that make up a chromophore of a molecule. The chromophore may be the part of a molecule that is responsible for the color of the molecule. As the oxidizing agent breaks the chemical bonds that make up the chromophore, the molecule may no longer include a chromophore, or may include a chromophore that does not absorb visible light. In this fashion, the oxidizing agent may remove a stain from a surface. The oxidizing agent may also disinfect a surface by breaking down chemical bonds of microbes. More specifically, the oxidizing agent may react with proteins in the microbes causing the bacteria to die off.

In one example, the oxidizing agent may be a bleach. More specifically, the bleach may be a chlorine-based bleach such as sodium hypochlorite, calcium hypochlorite, or chlorine. The bleach may be a peroxide-based bleach such as hydrogen peroxide, sodium percarbonate, or sodium perborate. The bleach may also be an oxygen-based bleach.

The cleaning agent may include a diluent. For example, the cleaning agent may include water for dissolving the molecules of the blemishes (102). The cleaning agent may also include an acid to further break down the blemishes (102). For example, the acids may remove inorganic material deposits. Examples of acids include hydrochloric acid and lauric acid. While the above examples have been described with reference to specific types of acids used in the cleaning agent, any appropriate acid or other type of agent may be used in accordance with the principles described herein. For example, other acids, such as nitric acid, sulfamic acid, citric acid, formic acid, hydroxyacetic acid, or combinations thereof may be included in the cleaning agent. Further, the cleaning agent may work in conjunction with non-aqueous agents.

The cleaning agent may include soap, or acid salts such as, citric acid salts, citrates, sodium citrates, monosodium citrate, sodium dihydrogen citrate, other types of salt, or combinations thereof. The acid salts may be used to directly assist with cleaning the surface, or the acid salts may indirectly assist with cleaning the surface such as by reducing water hardness. Other examples of acid salts or soaps that may be included in the cleaning agent are sodium tallowate, sodium cocoate, sodium palm kernalate, and sodium palmate. By using acid salts, an increased amount of acid may be delivered to the blemish (102) without increasing skin irritation to the user.

The cleaning agent may also include a surfactant. The surfactant may further assist in cleaning a surface by lowering the surface tension of a liquid or the interfacial tension between two liquids or between a liquid and a solid. When added to water, a surfactant significantly reduces the surface tension of the water allowing the water to penetrate the blemish (102) rather than slide off the surface (104). The result is that the water can function more effectively, acting to loosen the blemish (102) from the surface (104), and then hold the blemish (102) until the blemish (102) can be washed away.

Surfactants have a hydrophobic end and a hydrophilic end. The hydrophobic end has an uncharged carbohydrate group that can be straight, branched, cyclic or aromatic. Depending on the nature of the hydrophilic part, the surfactants are classified as anionic, nonionic, cationic or amphoteric. Anionic surfactants have a hydrophilic end that has a negatively charged group like a sulfonate, sulfate, or carboxylate and are sensitive to water hardness. Nonionic surfactants include a non-charged hydrophilic part, e.g. an ethoxylate. Nonionic surfactants are not sensitive to water hardness. Cationic surfactants have a hydrophilic end that contains a positively-charged ion. Amphoteric surfactants or Zwitterionic surfactants have both cationic and anionic centers attached to the same molecule. The surfactants in the cleaning product (100) may include any appropriate type of mixture of surfactants. For example, the surfactants may include a blend of anionic and nonionic surfactants. Specific examples of surfactants include sodium n-octyl sulfate, disodium dodecyldiphenyl ether disulfonate, lauryl dimethylamine oxide, and lauramine oxide.

In addition to those elements described above, the cleaning agent may include other compounds that remove blemishes (102) from a surface (104) and disinfect the surface (104). Examples include sodium hydroxide, aluminum distearate, cetyl dimethylamine oxide, sodium petroleum sulfonate, sodium silicate, sodium chloride, myristamine oxide and potassium iodide.

While the above examples have been described with reference to specific types of cleaning agents, any appropriate cleaning agent may be used in accordance with the principles described herein. For example, the cleaning agents may be used to remove blemishes (102), inhibit the formation of blemishes (102), or otherwise contribute to cleaning the blemishes (102). In some examples, the cleaning agent contributes directly to cleaning the blemishes (102) by directly working on the blemishes (102). In other examples, the cleaning agent indirectly cleans the blemishes (102). For example, the cleaning agent may lower the water hardness, affect the washing environment in another way, or combinations thereof. Further, the cleaning agent may include multiple types of cleaning agents that work on the blemishes (102). In such examples, each of the cleaning agents may perform different functions, perform overlapping functions, perform the same functions, or combinations thereof.

Moreover, while the examples above have been described with specific reference to cleaning agents that are acidic, the cleaning agent may have any appropriate property that contributes to cleaning a surface (104) in accordance with the principles described herein. For example, the cleaning agent may have an acidic property, an alkaline property, an abrasive property, a chemical property, a surfactant property, another type of property, or combinations thereof that contribute to cleaning fabric.

The cleaning product (100) may also include an alumina structuring agent with crystalline particles having a crystallite size less than six nanometers. The crystalline particles may bind the chemical components of the cleaning product (100). In some examples, current cleaning products may include crystalline particles having a crystallite size equal to or greater than six nanometers. For example, some existing cleaning products may include Catapal® D, which is a structuring agent product produced by the company Sasol, with United States headquarters in Houston, Tex. and Hayward, Calif., that has a crystallite size of approximately 7 nanometers. In another example, existing cleaning products may include Dispal® a structuring agent product also produced by Sasol, which is another structuring agent product. By comparison, the cleaning product (100) disclosed herein may include an alumina structuring agent with crystalline particles having a crystallite size less than six nanometers. In some examples, the alumina structuring agent may have a crystallite size equal to, or greater than four nanometers. For example, the cleaning product (100) may utilize boehmite alumina in the form of Catapal® B, which is an alumina structuring agent product produced by the company Sasol that has a crystallite size of approximately 4.5 nanometers. In another example, the cleaning product (100) may utilize Catapal® C1, which is an alumina structuring agent product produced by the company Sasol that has a crystallite size of approximately 5.5 nanometers. In yet another example, the alumina structuring agent may be Catapal® A. As described above, cleaning products (100) including these smaller particles exhibit an unexpectedly stable structure as compared to cleaning products formed from structuring agents with larger particle sizes. In some examples, the alumina structuring agent may have a surface area between 230 square meters per gram and 250 square meters per gram. Table (1) illustrates the different sizes of various Catapal® products produced by Sasol.

TABLE (1)

| | Catapal ® B | Catapal ® C1 | Catapal ® D |
|---|---|---|---|
| Al₂O₃ (%) | 72 | 72 | 76 |
| Na₂O (%) | 0.002 | 0.002 | 0.002 |
| Loose bulk density (g/l) | 670-750 | 670-750 | 500-700 |
| Packed bulk density (g/l) | 800-1100 | 800-1100 | 800-1100 |
| Particle size (μm) | 60 | 45 | 40 |
| Surface area (m²/g) | 250 | 230 | 220 |
| Pore volume (ml/g) | 0.50 | 0.50 | 0.55 |
| Crystallite size (nm) | 4.5 | 5.0 | 7.0 |

Again, current methods may utilize Catapal® D (fourth column) as an alumina structuring agent. By comparison, the alumina structuring agent described herein may include Catapal® B (second column), Catapal® C1 (third column), Catapal® A (not shown), or combinations thereof. While specific examples of alumina structuring agents have been described herein, any structuring agent having a crystallite size less than approximately six nanometers may be used in the cleaning product (100).

A cleaning product (100) with an alumina structuring agent having crystallite particles less than six nanometers may be beneficial in that it exhibits increased stability of the viscosity of the cleaning product (100) as well as a reduced amount of syneresis over time. Moreover, the level of the oxidizing agent in the cleaning product (100) is maintained, thus preserving the potency of the cleaning product (100).

A more specific example of the stability of a cleaning product (100) including an alumina structuring agent having crystallites less than six nanometers in size is given as follows. Viscosity may refer to the ability of a fluid to resist gradual deformation by sheer stress or tensile stress. In other words, viscosity may refer to the thickness of a fluid. Viscosity is generated in a fluid due to the friction between neighboring particles of fluid moving at different velocities. Specifically with regards to cleaning, a cleaning product (100) that has high viscosity may be beneficial to cling to vertical surfaces. For example, a high-viscous fluid may remain on a blemish (102) on a shower wall. By comparison, a low-viscous fluid may quickly drip down the shower wall, removed from the blemish (102). Over time, as a cleaning product (100) sits, the viscosity of the cleaning product (100) may be increased, thus reducing the efficacy of the cleaning product (100) as well as making the cleaning product (100) more difficult to use. To avoid this, alumina structuring agents may be added to maintain the viscosity. As indicated by Tables (2)-(10) below, an alumina structuring agent having crystallite particles less than six nanometers may exhibit an increased stability of the viscosity when compared to a control group containing an alumina structuring agent having crystallite particles greater than six nanometers.

In Tables (2)-(10), viscosity is indicated in units of centipoise. Tables (2)-(5) depict the change in viscosity for a control group (second row), a first group containing the alumina structuring agent Catapal® B (third row), and a second croup containing the alumina structuring agent Catapal® C1 (fourth row). Table (2) depicts the periodic change in viscosity of the cleaning product (100) at four degrees Celsius.

TABLE (2)

| | | | | | | Overall |
|---|---|---|---|---|---|---|
| | Initial | 2 Weeks | 4 weeks | 2 months | 3 months | change |
| | (cP) | (cP) | (cP) | (cP) | (cP) | (cP) |
| Control | 6200 | 5120 | 4960 | 4880 | 4800 | −1400 |
| Catapal ® | 6560 | 6160 | 6200 | 5880 | 5440 | −1120 |
| B | | | | | | |
| Catapal ® | 6840 | 5320 | 5240 | 5760 | 5720 | −1120 |
| C1 | | | | | | |

The second column of Table (2) depicts the initial viscosity of a control product utilizing Catapal® D, a product utilizing Catapal® B, and a product utilizing Catapal® C1. The third through sixth columns indicate the change in viscosity of the different products after two weeks, four weeks, two months, and three months, respectively. The last column indicates the overall change in viscosity for the three products after the three month period. As can be seen by the last column in Table (2), the Catapal® B and Catapal® C1 groups exhibited more viscosity stability than the control group as indicated by the lower overall change. Table (3) depicts the periodic change in viscosity of the cleaning product (100) at twenty degrees Celsius.

TABLE (3)

| | | 2 | 4 | 2 | 3 | 6 | 9 | 12 | Overall |
|---|---|---|---|---|---|---|---|---|---|
| | Initial | Weeks | weeks | months | months | months | months | months | change |
| | (cP) | (cP) | (cP) | (cP) | (cP) | (cP) | (cP) | (cP) | (cP) |
| Control | 6200 | 4200 | 4520 | 5200 | 5760 | 10040 | 15420 | 18240 | 12040 |
| Catapal ® | 6560 | 4440 | 4480 | 4680 | 4640 | 5120 | 5560 | 6160 | −400 |
| B | | | | | | | | | |
| Catapal ® | 6840 | 3880 | 4560 | 4720 | 5120 | 6280 | 7920 | 7520 | 680 |
| C1 | | | | | | | | | |

The second column of Table (3) depicts the initial viscosity of a control product utilizing Catapal® D, a product utilizing Catapal® B, and a product utilizing Catapal® C1. The third through ninth columns indicate the change in viscosity of the different products after two weeks, four weeks, two months, three months, six months, nine months, and twelve months, respectively. The last column indicates the overall change in viscosity for the three products after the twelve month period. As can be seen by the last column in Table (3), the Catapal® B and Catapal® C1 groups exhibited more viscosity stability than the control group as indicated by the lower overall change. Table (4) depicts the periodic change in viscosity of the cleaning product (100) at twenty five degrees Celsius.

TABLE (4)

| | | 2 | 4 | 2 | 3 | 6 | 9 | 12 | Overall |
|---|---|---|---|---|---|---|---|---|---|
| | Initial | Weeks | weeks | months | months | months | months | months | change |
| | (cP) | (cP) | (cP) | (cP) | (cP) | (cP) | (cP) | (cP) | (cP) |
| control | 6200 | 3760 | 5680 | 8680 | 16200 | 15800 | 9840 | 35800 | 29600 |
| Catapal ® | 6560 | 4000 | 5280 | 4680 | 4880 | 6720 | 8720 | 11240 | 4680 |
| B | | | | | | | | | |
| Catapal ® | 6840 | 3800 | 5160 | 6040 | 6440 | 12880 | 15720 | 14080 | 7240 |
| C1 | | | | | | | | | |

The second column of Table (4) depicts the initial viscosity of a control product utilizing Catapal® D, a product utilizing Catapal® B, and a product utilizing Catapal® C1. The third through ninth columns indicate the change in viscosity of the different products after two weeks, four weeks, two months, three months, six months, nine months, and twelve months, respectively. The last column indicates the overall change in viscosity for the three products after the twelve month period. As can be seen by the last column in Table (4), the Catapal® B and Catapal® C1 groups exhibited more viscosity stability than the control group as indicated by the lower overall change. Table (5) depicts the periodic change in viscosity of the cleaning product (100) at forty degrees Celsius.

TABLE (5)

| | | | | | | Overall |
|---|---|---|---|---|---|---|
| | Initial | 2 Weeks | 4 weeks | 2 months | 3 months | change |
| | (cP) | (cP) | (cP) | (cP) | (cP) | (cP) |
| control | 6200 | 6400 | 12000 | 17400 | 24360 | 18160 |
| Catapal ® | 6560 | 5320 | 8880 | 16000 | 15080 | 8520 |
| B | | | | | | |
| Catapal ® | 6840 | 5840 | 7960 | 9400 | 11680 | 4840 |
| C1 | | | | | | |

The second column of Table (5) depicts the initial viscosity of a control product utilizing Catapal® D, a product utilizing Catapal® B, and a product utilizing Catapal® C1. The third through sixth columns indicate the change in viscosity of the different products after two weeks, four weeks, two months, and three months, respectively. The last column indicates the overall change in viscosity for the three products after the three month period. As can be seen by the last column in Table (5), the Catapal® B and Catapal® C1 groups exhibited more viscosity stability than the control group as indicated by the lower overall change.

Tables (6)-(10) depict the change in viscosity for a control group (second row), a first group containing the alumina structuring agent Catapal® B (third row), and a second group also containing the alumina structuring agent Catapal® B (fourth row). Table (6) depicts the periodic change in viscosity of the cleaning product (100) at four degrees Celsius.

TABLE (6)

| | | | | | Overall |
|---|---|---|---|---|---|
| | Initial | 2 Weeks | 4 weeks | 2 months | change |
| | (cP) | (cP) | (cP) | (cP) | (cP) |
| control | 5960 | 5080 | 5240 | 5200 | −760 |
| Catapal ® B lot 1 | 8200 | 7680 | 7080 | 6800 | −1320 |
| Catapal ® B lot 2 | 8880 | 7520 | 7080 | 6800 | −2080 |

The second column of Table (6) depicts the initial viscosity of a control product utilizing Catapal® D, a first lot of a product utilizing Catapal® B, and a second lot of a product utilizing Catapal® B. The third through fifth columns indicate the change in viscosity of the different products after two weeks, four weeks, and two months, respectively. The last column indicates the overall change in viscosity for the three products after the two month period. Table (7) depicts the periodic change in viscosity of the cleaning product (100) at twenty degrees Celsius.

TABLE (7)

| | | | | | Overall |
|---|---|---|---|---|---|
| | Initial | 2 Weeks | 4 weeks | 2 months | change |
| | (cP) | (cP) | (cP) | (cP) | (cP) |
| control | 5960 | 4040 | 3980 | 5720 | −240 |
| Catapal ® B lot 1 | 8200 | 5200 | 5240 | 6800 | −1400 |
| Catapal ® B lot 2 | 8880 | 5320 | 5040 | 6360 | −2520 |

The second column of Table (7) depicts the initial viscosity of a control product utilizing Catapal® D, a first lot of a product utilizing Catapal® B, and a second lot of a product utilizing Catapal® B. The third through fifth columns indicate the change in viscosity of the different products after two weeks, four weeks, and two months, respectively. The last column indicates the overall change in viscosity for the three products after the two month period. Table (8) depicts the periodic change in viscosity of the cleaning product (100) at twenty five degrees Celsius.

TABLE (8)

| | | | | | Overall |
|---|---|---|---|---|---|
| | Initial | 2 Weeks | 4 weeks | 2 months | change |
| | (cP) | (cP) | (cP) | (cP) | (cP) |
| control | 5960 | 3960 | 5240 | 13400 | 7440 |
| Catapal ® B lot 1 | 8200 | 5160 | 5280 | 7600 | −600 |
| Catapal ® B lot 2 | 8880 | 5520 | 5640 | 7560 | −1320 |

The second column of Table (8) depicts the initial viscosity of a control product utilizing Catapal® D, a first lot of a product utilizing Catapal® B, and a second lot of a product utilizing Catapal® B. The third through fifth columns indicate the change in viscosity of the different products after two weeks, four weeks, and two months, respectively. The last column indicates the overall change in viscosity for the three products after the two month period. As indicated by the last column in Table (8), the lots of the products that contain Catapal® B, i.e., an alumina structuring agent having crystallite particles less than six nanometers, exhibit more viscosity stability than the control group as indicated by the lower overall change. Table (9) depicts the periodic change in viscosity of the cleaning product (100) at forty degrees Celsius.

TABLE (9)

| | | | | | Overall |
|---|---|---|---|---|---|
| | Initial | 2 Weeks | 4 weeks | 2 months | change |
| | (cP) | (cP) | (cP) | (cP) | (cP) |
| control | 5960 | 13040 | 18840 | 36000 | 30040 |
| Catapal ® B lot 1 | 8200 | 6760 | 9040 | 22480 | 14280 |
| Catapal ® B lot 2 | 8880 | 7640 | 9040 | 24200 | 15320 |

The second column of Table (9) depicts the initial viscosity of a control product utilizing Catapal® D, a first lot of a product utilizing Catapal® B, and a second lot of a product utilizing Catapal® B. The third through fifth columns indicate the change in viscosity of the different products after two weeks, four weeks, and two months, respectively. The last column indicates the overall change in viscosity for the three products after the two month period. As indicated by the last column in Table (8), the lots of the products that contain Catapal® B, i.e., an alumina structuring agent having crystallite particles less than six nanometers, exhibit more viscosity stability than the control group as indicated by the lower overall change. Table (10) depicts the periodic change in viscosity of the cleaning product (100) at fifty degrees Celsius.

TABLE (10)

| | | | | | Overall |
|---|---|---|---|---|---|
| | Initial | 2 Weeks | 4 weeks | 2 months | change |
| | (cP) | (cP) | (cP) | (cP) | (cP) |
| control | 5960 | 23440 | 22640 | — | 16680 |
| Catapal ® B lot 1 | 8200 | 20160 | 17960 | — | 9760 |
| Catapal ® B lot 2 | 8880 | 17640 | 16920 | — | 8040 |

The second column of Table (10) depicts the initial viscosity of a control product utilizing Catapal® D, a first lot of a product utilizing Catapal® B, and a second lot of a product utilizing Catapal® B. The third through fifth columns indicate the change in viscosity of the different products after two weeks, four weeks, and two months, respectively. The last column indicates the overall change in viscosity for the three products after the two month period. As indicated by the last column in Table (8), the lots of the products that contain Catapal® B, i.e., an alumina structuring agent having crystallite particles less than six nanometers, exhibit more viscosity stability than the control group as indicated by the lower overall change.

Accordingly, in general it is noted that alumina structuring agents having crystallite particles less than six nanometers exhibit more viscosity stability than alumina structuring agents having crystallite particles greater than six nanometers as indicated by Tables (2)-(10). Such findings represent an unforeseen result in the industry as general practice implements larger crystallite particles to improve structural stability.

An alumina structuring agent having crystallite particles less than six nanometers may also be beneficial by exhibiting a reduced amount of physical separation of a liquid. For example, typical cleaning products may be susceptible to syneresis, which is the expulsion of a liquid from a gel. Syneresis may reduce the efficacy of a cleaning product as active components of a cleaning product (100) may not be expelled from the container (106) at all, or at different (and perhaps less effective) concentrations. As indicated by Tables (11)-(15) below, an alumina structuring agent having crystallite particles less than six nanometers may exhibit a reduced occurrence of physical separation in the cleaning product (100). In Tables (11)-(15), physical separation is measured in millimeters of separation. Table (11) depicts the periodic physical separation of the cleaning product (100) at four degrees Celsius.

TABLE (11)

| | Initial | 2 Weeks | 4 weeks | 2 months | 3 months |
|---|---|---|---|---|---|
| | (mm) | (mm) | (mm) | (mm) | (mm) |
| control | — | 0 | 0 | 0 | ≦1 |
| Catapal ® B | — | 0 | 0 | 0 | 0 |
| Catapal ® C1 | — | 0 | 0 | 0 | ≦1 |

The second column of Table (11) depicts the initial separation of a control product utilizing Catapal® D, a product utilizing Catapal® B, and a product utilizing Catapal® C1. The third through sixth columns indicate the separation of the different products after two weeks, four weeks, two months, and three months, respectively. As can be seen by the last column of Table (11), the product utilizing Catapal® B exhibits less physical separation. Table (12) depicts the periodic change in separation of the cleaning product (100) at twenty degrees Celsius.

TABLE (12)

| | | 2 | 4 | 2 | 3 | 6 | 9 | 12 |
|---|---|---|---|---|---|---|---|---|
| | Initial | Weeks | weeks | months | months | months | months | months |
| | (mm) | (mm) | (mm) | (mm) | (mm) | (mm) | (mm) | (mm) |
| control | — | 0 | .5 | 1 | 2 | 3 | 4 | 3 |
| Catapal ® | — | 0 | 0 | .5 | 0 | 0 | 2 | 1 |
| B | | | | | | | | |
| Catapal ® | — | 0 | 1 | 1 | 2.5 | 3 | 4 | 4 |
| C1 | | | | | | | | |

The second column of Table (12) depicts the initial separation of a control product utilizing Catapal® D, a product utilizing Catapal® B, and a product utilizing Catapal® C1. The third through ninth columns indicate the separation of the different products after two weeks, four weeks, two months, three months, six months, nine months, and twelve months, respectively. As can be seen by the third row of Table (12), the product utilizing Catapal® B exhibits less physical separation. Table (13) depicts the periodic change in separation of the cleaning product (100) at twenty five degrees Celsius.

TABLE (13)

| | | 2 | 4 | 2 | 3 | 6 | 9 | 12 |
|---|---|---|---|---|---|---|---|---|
| | Initial | Weeks | weeks | months | months | months | months | months |
| | (mm) | (mm) | (mm) | (mm) | (mm) | (mm) | (mm) | (mm) |
| control | — | 0 | .5 | 2 | 2.5 | 3 | 3 | 3 |
| Catapal ® | — | 0 | 0 | .5 | 0 | 0 | 0 | 0 |
| B | | | | | | | | |
| Catapal ® | — | .5 | 1 | 2 | 2.5 | 3 | 3 | 2 |
| C1 | | | | | | | | |

The second column of Table (13) depicts the initial separation of a control product utilizing Catapal® D, a product utilizing Catapal® B, and a product utilizing Catapal® C1. The third through ninth columns indicate the separation of the different products after two weeks, four weeks, two months, three months, six months, nine months, and twelve months, respectively. As can be seen by the third row of Table (13), the product utilizing Catapal® B exhibits less physical separation. Table (14) depicts the periodic change in separation of the cleaning product (100) at forty degrees Celsius.

TABLE (14)

| | Initial | 2 Weeks | 4 weeks | 2 months | 3 months |
|---|---|---|---|---|---|
| | (mm) | (mm) | (mm) | (mm) | (mm) |
| control | — | 0 | 2 | 2 | 2 |
| Catapal ® B | — | 0 | .5 | .5 | 0 |
| Catapal ® C1 | — | 1 | 2 | 2 | 2 |

The second column of Table (14) depicts the initial separation of a control product utilizing Catapal® D, a product utilizing Catapal® B, and a product utilizing Catapal® C1. The third through sixth columns indicate the separation of the different products after two weeks, four weeks, two months, and three months, respectively. As can be seen by the third row of Table (14), the product utilizing Catapal® B exhibits less physical separation. Table (15) depicts the periodic change in separation of the cleaning product (100) at fifty degrees Celsius.

TABLE (15)

| | Initial | 2 Weeks | 4 weeks |
|---|---|---|---|
| | (mm) | (mm) | (mm) |
| control | — | 2 | 3 |
| Catapal ® B | — | 1 | 1 |
| Catapal ® C1 | — | 2 | 3 |

The second column of Table (15) depicts the initial separation of a control product utilizing Catapal® D, a product utilizing Catapal® B, and a product utilizing Catapal® C1. The third and fourth columns indicate the separation of the different products after two weeks and four weeks, respectively. As can be seen by the third row of Table (15), the product utilizing Catapal® B exhibits less physical separation.

Accordingly, in general it is noted that alumina structuring agents having crystallite particles less than six nanometers may exhibit less separation and/or syneresis than alumina structuring agents having crystallite particles greater than six nanometers as indicated by Tables (11)-(15). Such findings represent an unforeseen result in the industry as general practice implements larger crystallite particles to improve structural stability.

In some examples, anti-bacterial ingredients, malodor controlling ingredients, or combinations thereof may be included in the cleaning product (100) to provide the cleaning product (100) with a pleasant smell. A non-exhaustive list of anti-bacterial ingredients and malodor controlling ingredients that may be used in the cleaning product (100) include triclosan, triclocarban, usnic acid salts, zinc phenolsulfonate, b-chloro-D-alanine, D-cycloserine, animooxyacetic acid, cyclodextrine, sodium bicarbonate, and combinations thereof. Further, the cleaning product (100) may include preservatives and viscosity modifiers. The viscosity modifiers may control how easily the cleaning product (100) flows through the opening (108) of the container (106).

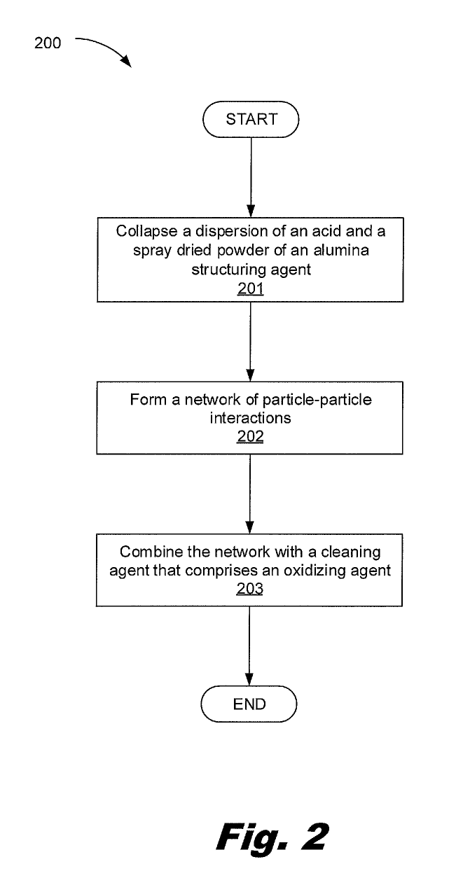

FIG. 2 is a flowchart of a method (200) for forming a cleaning product (100) exhibiting increased stability with crystalline particles according to the principles described herein. The method (200) may include collapsing (block 201) a dispersion of an acid and a spray dried powder of an alumina structuring agent. As described above, the alumina structuring agent may include crystalline particles having a crystallite size less than six nanometers. A cleaning product (FIG. 1, 100) having an alumina structuring agent including crystallite particles less than six nanometers may exhibit an enhanced stability. More specifically, the cleaning product (FIG. 1, 100) may exhibit a reduced increase in viscosity over time and may also exhibit a reduced syneresis (i.e., physical separation of a liquid from the gel), both of which may increase the efficacy of the cleaning product (FIG. 1, 100). Accordingly, a cleaning product (FIG. 1, 100) with small crystallite sizes may (1) exhibit an increased cleaning ability, (2) increase consumer experience with the cleaning product (FIG. 1, 100) as the product is overall easier to use, and (3) preserve the active bleach level in the cleaning agent. In some examples, collapsing (block 201) a dispersion of an acid and a spray dried powder of an alumina structuring agent may include deconstructing crystallites of the alumina structuring agent into individual particles.

The method (200) may also include forming (block 202) a network of particle-particle interactions. For example, a pH of the dispersion (of acid and the spray dried powder) may be raised under shear conditions to re-aggregate the individual particles into an equilibrium structure. The network may be stabilized by the electrostatic repulsive forces within the dispersion.

The method (200) may also include combining (block 203) the network with a cleaning agent that comprises an oxidizing agent. As described the cleaning agent may be any agent that removes blemishes (FIG. 1, 102) from a surface (FIG. 1, 104). The oxidizing agent may oxidize the blemish (FIG. 1, 102) to remove color, expel blemish (FIG. 1, 102) molecules from the surface (FIG. 1, 104), kill microbes on the surface (FIG. 1, 104), or combinations thereof.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A cleaning product exhibiting increased stability with crystalline particles, comprising:
a cleaning agent disposed within the cleaning product, the cleaning agent comprising an oxidizing agent; and
an alumina structuring agent disposed within the cleaning product comprising crystalline particles having a crystallite size less than six nanometers.

2. The cleaning product of claim 1, wherein the crystalline particles have a crystallite size greater than four nanometers.

3. The cleaning product of claim 1, wherein the alumina structuring agent is boehmite alumina.

4. The cleaning product of claim 1, wherein the crystalline particles have a surface area of between 230 square meters per gram and 250 square meters per gram.

5. The cleaning product of claim 1, wherein the cleaning agent is configured to clean hard surfaces.

6. The cleaning product of claim 1, wherein the cleaning product further comprises an anti-bacterial ingredient, a malodor controlling ingredient, or combinations thereof.

7. The cleaning product of claim 1, wherein the cleaning agent comprises water, an acid and a surfactant.

8. The cleaning product of claim 1, wherein the oxidizing agent is bleach.

9. A surface cleaning product exhibiting increased stability with crystalline particles, comprising:
a container; and
a cleaning product housed within the container, wherein the cleaning product includes:
a cleaning agent disposed within the cleaning product, the cleaning agent comprising an oxidizing agent; and
an alumina structuring agent disposed within the cleaning product comprising crystalline particles having a crystallite size less than six nanometers.

10. The surface cleaning product of claim 9, wherein the crystalline particles have a crystallite size greater than four nanometers.

11. The surface cleaning product of claim 9, wherein the alumina structuring agent is boehmite alumina.

12. The surface cleaning product of claim 9, wherein the crystalline particles have a surface area of between 230 square meters per gram and 250 square meters per gram.

13. The surface cleaning product of claim 9, wherein the cleaning agent is configured to clean hard surfaces.

14. The surface cleaning product of claim 9, wherein the cleaning product further comprises an anti-bacterial ingredient, a malodor controlling ingredient, or combinations thereof.

15. The surface cleaning product of claim 9, wherein the cleaning agent comprises lauramine oxide, sodium tallowate, sodium cocoate, sodium palm kernelate, sodium palmate, sodium hydroxide, myristamine oxide, potassium iodide, hydrochloric acid, sodium silicate, calcium carbonate, sodium laurate, or combinations thereof.

16. The surface cleaning product of claim 9, wherein the container comprises an opening that allows the cleaning product to flow out of the container.

17. The surface cleaning product of claim 9, wherein the container comprises a spray opening that ejects the cleaning product out of the container.

18. A method for forming a cleaning product exhibiting increased stability with crystalline particles, comprising:
collapsing a dispersion of an acid and a spray dried powder of an alumina structuring agent; and
forming a network of particle-particle interactions;
combining the network with a cleaning agent that comprises an oxidizing agent;
in which the alumina structuring agent comprises crystalline particles having a crystallite size less than six nanometers.

19. The method of claim 18, wherein collapsing a dispersion of an acid and a spray dried power of an alumina structuring agent comprises deconstructing crystallites of the alumina structuring agent.

20. The method of claim 18, wherein forming a network of particle-particle interactions comprises raising a pH of the dispersion under shear conditions to re-aggregate individual particles of the alumina structuring agent into an equilibrium structure.
